(19) United States
(12) Patent Application Publication
(10) Pub. No.: US 2005/0005801 A1
(43) Pub. Date: Jan. 13, 2005

(54) Method and device for forming a surface structure on a wafer

(76) Inventor: Erich Thallner, Scharding (AT)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 10/884,505

(22) Filed: Jul. 2, 2004

(30) Foreign Application Priority Data
Jul. 5, 2003 (DE) 103 30 456.8

(51) Int. Cl. B41M 1/00

(52) U.S. Cl. 101/483

(57) ABSTRACT

A device for forming a surface structure on a wafer. The device includes a support (18) for receiving the wafer (10), and a holder (20) that accommodates a stamp (14). The stamp (14) has a profiling (16) corresponding to the surface structure to be formed on the wafer. The profiling (16) has at least one section and/or at least one additional adjusting mark that is repeated in a direction of movement of the stamp (14).

The invention relates to a method and a device for forming a surface structure on a wafer.

The term “wafer” according to the invention stands as a representative of all types of disk-shaped objects of any form. Especially included are silicon disks used to manufacture semiconductors.

The wafers are processed and treated in a wide range of process steps. These include for example, aligning, etching, coating or cleaning wafer surfaces. Also included here is the construction or application of electrical conductor paths or components.

In order to form such structures on a wafer surface, it is known to coat the wafer with a so-called photo-varnish and then image the desired structures photographically thereon.

It is also known to heat the wafer surface to make it deformable. The structure is then pressed into the deformable wafer surface with the aid of a stamp. For this purpose the wafer surface consists mainly of a thermoplastic plastic.

Extreme requirements with regard to dimensional accuracy are imposed on the respective surface structure. Especially in the case of larger wafers (diameter 300 mm or more), several stamping steps must therefore be carried out one after the other since only smaller stamps can ensure the corresponding dimensional accuracy. Then however there is the problem of ensuring that the stamp steps are exactly aligned to one another, that is for example, the exact parallelism of line structures formed in different stamping steps

US 2002/0 170 880 A1 relates to a lithographic method and a device, which describes the alignment of a patterned skeleton form with reference to alignment marks which are arranged on a substrate wherein this depends on the interaction of a scanner with the alignment marks.

The publication U.S. Pat. No. 5,817,242 also relates to an alignment device which describes an optical alignment by means of sensors.

The invention should indicate a possibility for reproducibly forming or imaging precise structures on a wafer surface.

AT 410 149 B describes a method for applying a coating to substrates wherein the coating is applied in a mouldable state. A structure of the coating is produced by a impressed forming stamp.

The invention starts from the stamping technology described previously and extends this as follows: the individual stamping steps to form large-area structures should not be carried out next to one another but partly overlapping.

This has the advantage that structures formed in a first stamping step can be partly used for “self-adjustment” of a following stamping step. The further stamping steps can be carried out such that an alignment takes place on any one of the previously formed structures wherein respectively the closest structures can also be selected. This should be illustrated using a very simple example:

A rectangular stamp is used, which has two web-shaped profile elevations running parallel to one another. In a first stamping step, two grooves are accordingly stamped into the wafer surface. According to the invention, the next stamping step does not take place adjacent to the first stamp step but partly overlapping, wherein the stamp is only displaced so far until the one profiling stands above the structure line formed previously by the other profiling. The stamp is then lowered, wherein the profiling can adjust itself in the already existing structure and in this further stamping step only one further structure line (using the second web) is formed.

Since the stamp profile can align (adjust) itself in a previously formed structure, an optimal dimensional accuracy is obtained in the simplest way. In this case, lithographic methods or other optical methods for adjustment can be partly or completely dispensed with. The preceding example shows that the principle according to the invention can be varied in numerous ways, especially also for more complex structures. For example, the method can be applied not only to stamps which are linearly displaced but definitely also to stamps which are moved along a curved line, for example, a circular line or along another geometrical Fig.

Whereas a corresponding holder for the stamp is merely used for coarse adjustment, the fine adjustment can be carried out in situ using the profiling/structure.

The individual stamping steps can be controlled by a control device which is constructed to control the movement of the stamp such that this stamps successively adjacent sections in the wafer surface and in this case, the profiling of the stamp engages at least partly in the formed surface structure which has already hardened under certain circumstances. In this case, the control device can allow self-adjustment to the previously formed structure.

In its most general form, the invention relates to a method for forming a surface structure on a wafer having the features of claims 12 to 18. Furthermore, the invention relates to a device having the features of claims 1 to 11 and 19.

“Stamp width” describes the maximum extension of the stamp or its profiling in the direction of displacement of the stamp.

The term “adjusting mark” comprises any type of marking in order to achieve the desired exact alignment of the stamp insofar as this is not possible via an already existing surface structure. This should also be illustrated with reference to an example:

Assuming that the profiling/surface structure consists of a circular line, it is clearly not possible to displace the stamp and re-align with respect to the surface structure formed previously in the fashion described previously. However, in this case, for example four adjusting marks (recesses) can be formed on the wafer surface at four corner points of the stamp, of which two are used for adjustment for a further stamping process after a partial displacement of the stamp.

The stamp can have a “positive” or a “negative” profiling or adjusting mark. “Positive” means that the profiling (this term hereinafter always includes the corresponding adjusting mark(s)) projects in the direction of the wafer surface to be treated. In this case, it can be provided to form the profiling harder than the wafer surface to be treated in order to make it possible to achieve exact stamping.

“Negative” profiling is correspondingly conversely then provided if the profiling is formed as a “recess” in the stamp so that after the stamping process the wafer surface structure can be identified as suitably “raised”.

The wafer surface can be a separate coating. Materials for the wafer surface/coating to be stamped can for example be UV-hardenable materials such as UV hardenable polymers. The stamp material or material for the profiling can be glass such as quartz glass or polydimethyl siloxane. An additional anti-adhesive coating is helpful.

A further stamp alternative is conFigd as follows: instead of a stamp which is hard right through, this is formed as hard only in one, for example, outer region, as described previously. In another, for example, inner region, on the other hand the stamp is formed as soft and flexible. Thus, in a first step adjusting/stamping patterns can be formed which a subsequently processed in one or further steps. For this purpose, the “soft part” of the sample can, for example, be wetted with a medium (substrate) which is transferred to the wafer surface during the stamping process and is then hardened or used for further chemical or optical treatment steps.

The hardening can take place by heat but for example, also by light, for example, UV light. In this case, it is possible to construct at least the stamp, if necessary also the adjacent components of the holder, from a UV-transparent material. Device has corresponding additional equipment.

According to one embodiment, the holder of the stamp is shaped such that the stamp has free mobility parallel and/or perpendicular to the wafer surface to be treated. After the coarse adjustment described, this provides the opportunity of using the structures formed for further automatic adjustment for the subsequent stamping process.

One variant provides that adjusting marks are initially formed using the (hard) stamp described and these are used in a further step for adjusting a (soft) stamp to apply structures to the wafer.

Further features of the invention are obtained from the features of the dependent claims and the other application documents.

In this case the Figs show—highly schematically in each case—individual steps of the method to be carried out using the device to forme a surface structure on a wafer and specifically

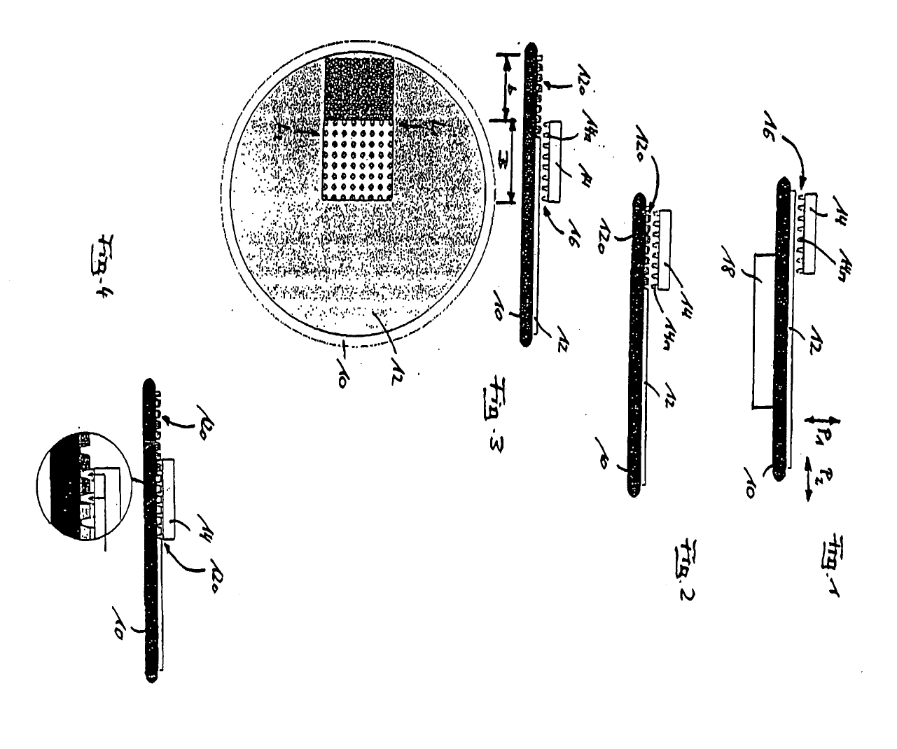

FIG. 1 shows a wafer on a support with a stamp arranged above the wafer,

FIG. 2 shows a diagram according to FIG. 1 wherein part of the wafer surface is already stamped with the stamp,

FIG. 3 shows a diagram according to FIG. 2 after displacement of the stamp and a plan view below,

FIG. 4 shows a diagram according to FIG. 3 (top) wherein the stamp executes a further stamping process, supplemented by an enlarged partial diagram.

In the Figs a wafer is shown by the reference number 10, its surface to be treated is shown as polymer layer 12, a transparent stamp by 14 and its profiling by 16, and knobs of the profiling 16 are denoted by the reference number 14n.

The wafer 10 is guided on a support 18. The stamp 14 is accommodated in a holder and guided, its direction of movement being specified by arrows P₁, P₂.

In the initial situation (FIG. 1) the polymer layer 12 is viscous and deformable. The stamp 14 is brought into position (as shown).

In the next step (FIG. 2) the stamp 14 is guided in the direction of the arrow P₁ (lowered) until the knobs 14n of the profiling 16 penetrate into the polymer layer 12. Here the knobs 14n consist of truncated-cone-shaped elevations which correspondingly form discrete openings 12o in the surface layer 12, whose diameter at the base is smaller than that in the upper region of the opening.

In the next step UV light is guided through the transparent stamp 14 onto the polymer layer 12 which hardens. FIG. 2 shows the device after the stamp 14 has been released from the surface 12.

The stamp 14 is then moved laterally in the direction of the arrow P₂ (FIG. 3) but by a width b smaller than the total width B (in the direction of the arrow P₂) of the stamp 14. As can be deduced from FIG. 3, the displacement path was selected here such that 6 rows of holes are exposed whilst in the displacement direction P₂ the last two rows of holes L1 and L2 remain covered by the stamp 14, so that the corresponding knobs 14n can then penetrate again into the corresponding holes 12o of the surface structure already formed during the first stamping process if the stamp 14 is again guided in the direction of the arrow P₁ towards the wafer surface 12. In this case, as is indicated schematically in FIG. 4, a mechanical fine adjustment of the knobs 14n in the corresponding recesses 12o is obtained along the rows of holes L1, L2. As a result, the recesses 12o stamped into the substrate surface 12 in this second stamping step are exactly and definedly aligned in relation to the recesses 12o which were formed in a first stamping step.

A further UV hardening of the polymer layer 12 then takes place. The stamp 14 can then be removed again in the manner described.

This process can be repeated arbitrarily frequently. In this case, for example, the stamp can also be displaced in a direction 90° to the direction described previously. With corresponding profilings or surface structures, other directions of movement including curved movements can also be executed without departing from the principle of the invention.

FIG. 2 also shows a plan view to clarify a structure formed (here: 64 recesses 12o in 8×8 rows).

The surface structure thus formed is then available for further finishing, for example, partial etchings, arrangement of conductor paths, integration of electronic components or the like.

1. Device for forming a surface structure on a wafer (10), having the following features:
a) a support (18) for receiving the wafer (10) such that a wafer surface (12) to be treated is exposed, and
b) a holder (20) which accommodates a stamp (14) and guides
b1) perpendicular to and towards the wafer surface (12) to be treated, and
b2) parallel to the wafer surface (12) to be treated in steps of respectively less than one stamp width, wherein
c) on its side facing the wafer surface (12) to be treated the stamp (14) has a profiling (16) corresponding to the surface structure to be formed and the profiling (16)
d1) has at least one section and/or
d2) at least one additional adjusting mark, which
d3) is repeated in the direction of movement of the stamp (14).

2. Device according to claim 1 comprising a stamp (14) whose profiling (16) or adjusting mark projects in the direction of the wafer surface (12) to be treated.

3. Device according to claim 2 wherein the profiling (16) is harder than the wafer surface (12) to be treated.

4. Device according to claim 1 comprising a stamp whose profiling or adjusting mark stands back in the direction of the wafer surface to be treated.

5. Device according to claim 1 comprising a stamp which partly consists of a material which is softer than the wafer surface to be treated.

6. Device according to claim 1 comprising a transparent stamp (14).

7. Device according to claim 1 whose holder (20) is shaped such that the stamp (14) has free mobility parallel and/or perpendicular to the wafer surface (12) to be treated.

8. Device according to claim 1 comprising a device for hardening the surface structure formed on the wafer surface (12).

9. Device according to claim 1 comprising a control device which is constructed to control the movement of the stamp such that this stamps successively adjacent sections in the wafer surface and the profiling 16 of the stamp 14 engages in this case at least partly into the formed, hardened surface structure.

10. Device according to claim 9, wherein the control device allows self-adjustment by meshing of the meshing parts.

11. Device according to claim 8, wherein the device is a device for UV light hardening.

12. Method for forming a surface structure on a wafer, having the following features.
a) in a first stamping step structures are formed in a surface of the wafer using a stamp profile of a stamp,
b) a further stamping step for forming a further structure is executed partly overlapping to the previously formed structure, wherein
c) the structure formed in the first stamping step is partly used for self-adjustment of the further stamping step.

13. Method for forming a surface structure on a wafer surface of a wafer comprising the following steps:
a) by means of a holder for receiving and guiding a stamp which can be displaced perpendicular and parallel to the wafer surface, said stamp is positioned above a first section
b) a profiling arranged on the stamp is pressed into the wafer surface of the wafer
c) the wafer surface is hardened by means of a device for hardening the wafer surface in the area of the first section.
d) the stamp is moved away from the wafer surface again and is then displaced by a width b smaller than the total width B such that the stamp is positioned above a further section partly identical to the first/previous section, wherein the profiling of the stamp is positioned over corresponding, hardened recesses of the wafer surface.
e) Steps b) and c) are repeated for this section, wherein the exact positioning is accomplished by allowing a mutual alignment of the corresponding profilings and recesses.
f) the method is continued with step d) until the desired number of sections has been stamped.

14. Method according to claim 13, wherein the profiling consists of knobs which are formed as truncated-cone-shaped raisings.

15. Method according to claim 13, wherein the device for hardening the wafer surface guides UV light through the transparent stamp onto the wafer surface.

16. Method according to any one of the preceding claims 13 to 15, wherein the wafer surface is a polymer layer.

17. Method according to claim 13, wherein each section consists of an array of 8 times 8 recesses, wherein two rows are positioned such that they overlap in step d).

18. Method for forming a surface structure on a wafer (10) having the following features:
a) the wafer (10) is accommodated on a support (18) such that a wafer surface (12) to be treated is exposed,
b) a stamp (14) accommodated by a holder (20) which has, on its side facing the wafer surface (12) to be treated, a profiling (16) corresponding to the surface structure to be formed is guided
b1) parallel to the wafer surface (12) to be treated in steps of respectively less than one stamp width and
b2) perpendicular to and towards the wafer surface (12) to be treated and away from this, forming a part of the desired surface structure, wherein
c) successive stamping steps for forming the desired surface structure are executed such that they partly overlap and the profiling (16) has
e1) at least one section and/or
e2) at least one additional adjusting mark which
e3) is repeated in the direction of movement of the stamp (14).

19. A device for forming a surface structure on a wafer (10) according to the method according to claim 18.
